(19) United States
(12) Patent Application Publication
(10) Pub. No.: US 2019/0280294 A1
(43) Pub. Date: Sep. 12, 2019

(54) ACTIVE MATERIAL FOR A POSITIVE ELECTRODE OF A BATTERY CELL, POSITIVE ELECTRODE, AND BATTERY CELL

(71) Applicant: Robert Bosch GmbH, Stuttgart (DE)

(72) Inventors: Anika Marusczyk, Stuttgart (DE); Thomas Eckl, Leonberg (DE)

(21) Appl. No.: 16/461,179

(22) PCT Filed: Oct. 11, 2017
(86) PCT No.: PCT/EP2017/075903

§ 371 Date: May 15, 2019

(30) Foreign Application Priority Data
Nov. 24, 2016 (DE) 10 2016 223 246.0

(51) Int. Cl. H01M 4/505; H01M 4/36; H01M 4/62; H01M 10/0525

(52) U.S. Cl. CPC H01M 4/505; H01M 4/366; H01M 2004/028; H01M 10/0525; H01M 4/625

(57) ABSTRACT

A positive active material for a positive electrode of a battery cell, includes a first component which contains Li₂MnO₃. The first component is doped with aluminum fluoride ions which replace a portion of the oxygen ions O²⁻ and a portion of the manganese ions Mn⁴⁺ of the component. Also described is a positive electrode of a battery cell, which encompasses a positive active material, as well as to a battery cell which encompasses at least one positive electrode.

### FIELD OF THE INVENTION

The present invention relates to an active material (A) for a positive electrode of a battery cell, which includes a first component (A1) which contains Li₂MnO₃ doped with aluminum fluoride ions. The present invention also relates to a positive electrode of a battery cell, which includes an active material (A) according to the present invention, as well as to a battery cell which includes at least one positive electrode according to the present invention.

### BACKGROUND INFORMATION

The storage of electrical energy has taken on increasing significance in recent decades. Electrical energy is storable with the aid of batteries. Batteries convert chemical reaction energy into electrical energy. A distinction is made in this case between primary batteries and secondary batteries. Primary batteries are capable of functioning only once, while secondary batteries—which are also referred to as accumulators—are rechargeable. A battery includes one or multiple battery cells.

So-called lithium-ion battery cells, in particular, are utilized in an accumulator. These are distinguished by, inter alia, high energy densities, thermal stability, and an extremely low self-discharge.

Lithium-ion battery cells include one positive electrode and one negative electrode. The positive and the negative electrodes each include a current collector, on which a positive and a negative active material, respectively, has been applied. The positive and the negative active materials are characterized, in particular, by the fact that they are capable of reversible intercalation and removal of lithium ions.

The active material for the negative electrode is, for example, amorphous silicon which may form intercalation compounds with lithium atoms. Carbon compounds such as, for example, graphite, are also widespread as active material for negative electrodes. Lithium ions have been intercalated into the active material of the negative electrode.

A lithium-containing metal oxide or a lithium-containing metal phosphate is generally used as active material for the positive electrode. In applications, in particular, in which a high energy density is necessary, so-called high-energy materials, such as HE (high energy)-NCM (nickel cobalt manganese) electrodes (for example, LiMO₂:Li₂MnO₃ where M=Ni, Co, Mn) are utilized. A battery which utilizes such an HE-NCM electrode is known, for example, from DE 10 2012 208 321 A1.

During the operation of the battery cell, i.e., during a discharge process, electrons flow from the negative electrode to the positive electrode in an external circuit. Within the battery cell, lithium ions migrate from the negative electrode to the positive electrode during the discharge process. In this case, the lithium ions are reversibly removed from the active material of the negative electrode, which is also referred to as delithiation. In a charging process of the battery cell, the lithium ions migrate from the positive electrode to the negative electrode. In this case, the lithium ions are reversibly intercalated into the active material of the negative electrode again, which is also referred to as lithiation.

The electrodes of the battery cell may be configured to be foil-like and are wound to form an electrode coil having a separator therebetween, which separates the negative electrode from the positive electrode. Such an electrode coil is also referred to as a jelly roll. The electrodes may also be stacked one above the other to form an electrode stack.

The two electrodes of the electrode coil or of the electrode stack are electrically connected to poles of the battery cells, which are also referred to as terminals, with the aid of collectors. One battery cell generally includes one or multiple electrode coils or electrode stacks. The electrodes and the separator are surrounded by an electrolyte composition which is generally liquid. The electrolyte composition is conductive for the lithium ions and enables the transport of the lithium ions between the electrodes.

Patent document US 2014/0141331 A1 discusses a cathode active material having a layered structure for lithium-ion batteries, which includes a lithium metal composite component containing lithium in excess, containing Li₂MnO₃. The cathode material is doped with a fluorine component, such as lithium fluoride. In order to prepare the lithium metal composite component, a transition metal precursor compound, a lithium source such as Li₂CO₃ or LiOH, and a fluorine component are homogeneously mixed and heated.

In the reference of A. K. Varanasi et al. in “Electrochemical potentials of layered oxide and olivine phosphate with aluminum substitution: A first principles study”, Bulletin of Materials Science, Volume 36, Issue 7, pages 1331 through 1337 investigate the effect of aluminum substituents on the electrochemical potential of LiCoO₂, LiFePO₄, and LiCoPO₄.

Other HE-NCM electrodes may be distinguished by the fact that they deliver high cell voltages at the beginning of the service life of the cell; the cell voltages, however, are subjected to considerable losses in the course of the service life (so-called voltage fade). The same applies for the capacity of the cell (so-called capacity fade). The object of this present invention is therefore to provide an active material for a positive electrode, which has a high cell voltage and capacity even after a long service life of the cell.

### SUMMARY OF THE INVENTION

An active material (A) for a positive electrode of a battery cell, in particular, for a lithium-ion battery cell, is provided, which encompasses a first component (A1) which contains a metal oxide of the formula (I):

Li₂MnO₃ (I)

According to the present invention, the first component (A1) of the active material (A) is doped with aluminum fluoride ions.

Due to the doping, a portion of 0.1 mole percent to 15 mole percent of the oxygen ions O²⁻ of the metal oxide Li₂MnO₃ of the first component (A1) of the active material (A) of the positive electrode may be replaced by the fluoride ions F⁻. In particular, it may be provided when a portion of 1 mole percent to 10 mole percent of the oxygen ions O²⁻ of the Li₂MnO₃ may be replaced by fluoride ions F⁻.

Moreover, due to the doping, a portion of 0.1 mole percent to 15 mole percent of the manganese ions Mn⁴⁺ of the metal oxide Li₂MnO₃ of the first component (A1) of the active material (A) of the positive electrode may be replaced by the aluminum ions Al³⁺ in order to compensate for a portion of the missing negative charges due to the doping with the fluoride ions F⁻. In particular, it may be provided that when a portion of 1 mole percent to 10 mole percent of the manganese ions MN⁴⁺ of the Li₂MnO₃ may be replaced by aluminum ions Al³⁺. The ratio of the dopant atoms Al:F may be 1:3.

In addition, a charge compensation takes place by reducing manganese ions Mn⁴⁺ to manganese ions Mn³⁺.

The component (A1) according to the present invention therefore encompasses at least one compound which may be represented by the following formula (II):

Li₂Mn_{1-y}Al_{y}O_{3-3y}F_{3y} (II)

where 0.15>y>0. Still further, it may be 0.1≥y>0, and in particular 0.05≥y>0.

According to one advantageous embodiment of the present invention, the component (A1) is additionally doped with natrium ions, a portion of the lithium ions of the component (A1) being replaced by natrium ions. As a result, the rate capability of the active material (A) is positively affected. The advantageous configuration therefore encompasses a component (A1) of the general formula (III):

Li_{2-z}Na_{z}Mn_{1-y}Al_{y}O_{3-3y}F_{3y} (III)

where y has the above-defined significance and 0.2>z≥0. It may be 0.1≥z≥0.05.

The active material (A) may include a second component (A2) which contains LiMO₂. In this case, M is a transition metal, which may be selected from the elements nickel, cobalt, and manganese. The active material (A), which encompasses the components (A1) and (A2), allows for a relatively large capacity of the battery cells connected with a relatively high voltage.

In general, the doping of the first component (A1) of the active material (A) of the positive electrode, which contains the metal oxide Li₂MnO₃, with the aluminum fluoride ions yields a material having the formula (III).

The initially inactive first component (A1) of the active material (A) of the positive electrode, which contains the metal oxide Li₂MnO₃, is activated during the forming cycle of the battery cell, accompanied by irreversible splitting-off of oxygen. The forming of the battery cell takes place in that a defined voltage is applied to the battery cell for the first time and a defined current flows through the battery cell for the first time. Such a method for forming a battery cell, in which forming currents are impressed into the battery cell in order to activate electrochemical processes, is known, for example, from the publication DE 10 2012 214 119 A1. The doping of the first component (A1), which contains the metal oxide Li₂MnO₃, takes place during the synthesis and before the aforementioned forming and activation of the battery cell.

During the doping, oxygen ions O²⁻ of the metal oxide Li₂MnO₃ are proportionally replaced by fluoride ions F⁻, manganese ions Mn⁴⁺ of the metal oxide Li₂MnO₃ are proportionally replaced by aluminum ions Al³⁺, and manganese ions Mn⁴⁺ are proportionally reduced to manganese ions Mn³⁺. Manganese ions Mn³⁺, in contrast to manganese ions Mn⁴⁺, may participate, via oxidation, in the charge compensation during delithiation and, therefore, represent new redox centers. Aluminum ions Al³⁺ have a stabilizing effect on the structure and voltage level of the material and have a similar ion radius as manganese ions Mn⁴⁺.

As a result, the situation is prevented in which oxygen is forced, from the outset, to undergo charge compensation and, therefore, irreversible splitting-off during the activation, whereby the structure and the capacity of the material is stabilized, so that the stability of the voltage is positively affected.

Due to the provided doping of the first component (A1), which contains Li₂MnO₃, in particular due to the redox activity of the manganese ions Mn³⁺, the irreversible oxygen loss is reduced. Since a reduction of the flaws in the material is achieved in this way, the destabilization of the material structure due to rearrangements and migrations of transition metals in the positive active material is also reduced. This results in a stabilization of the capacity and the voltage level, since the active material is subjected to fewer changes.

Moreover, the doping according to the present invention has a positive effect on the rate capability. Moreover, the lithium-rich phase has an isolator behavior. However, there are no indications for a phase separation as in pure Li₂MnO₃, whereby an insulating layer does not form in the particle.

Due to doping, in a targeted manner, of only the first component (A1), which contains Li₂MnO₃, an unnecessary doping of the component (A2) containing the NCM compound LiMO₂ is avoided. Since the second component (A2), which contains the NCM compound LiMO₂, is already stably cyclable, an incorporation of fluoride ions and aluminum ions into the second component (A2), which contains the NCM compound LiMO₂, would represent an impurity which reduces the overall performance of the material.

The doping may result in a reduction of the initial voltage, which is necessarily associated with the redox activity of the manganese ions Mn³⁺ of approximately 3 V (see FIG. 3). Although the average voltage of the material which has been doped according to the present invention is approximately 4% lower as compared to non-aged starting material, the gravimetric, theoretical capacity increases by up to 2%, as a function of the dopant amount, due to the low weight of the dopant elements, so that an energy density is achieved, which is increased by up to 11% as compared to undoped, aged material which already has a pronounced loss of cell voltage after a few cycles (see FIG. 3).

In contrast to a coating with aluminum fluoride, in the case of a doping with aluminum fluoride ions, the described positive effect is achieved in the entire material and is not limited only to the surface.

In general, the aforementioned doping yields an active material (A) of the positive electrode including a first component (A1), which contains the aluminum fluoride-doped metal oxide Li₂MnO₃, and including a second component (A2), which contains the NCM compound LiMO₂, according to the following formula (IV):

a(LiMO₂):1-a(Li_{2-z}Na_{z}Mn_{1-y}Al_{y}O_{3-3y}F_{3y}) (IV)

where M, z, and y have the above-defined significance and 1>x≥0. It may be 0.8>a>0.2, and in particular 0.7≥a≥0.4.

A positive electrode of a battery cell is also provided, which encompasses an active material (A) according to the present invention.

According to an advantageous refinement of the present invention, a coating containing AlF₃ is applied on the active material (A) of the positive electrode. A coating of the active material (A) of the positive electrode with aluminum fluoride positively affects the capacity of the battery cell.

In particular, the aforementioned coating prevents or reduces a contact of the active material (A) of the positive electrode with an electrolyte composition contained in the battery cell. Therefore, washing transition metals out of the active material (A) of the positive electrode and migration of washed-out transition metals to the negative electrode of the battery cell are likewise prevented or reduced.

According to a further advantageous refinement of the present invention, a coating containing carbon is applied on the active material (A) of the positive electrode. Such a coating ensures a homogeneous electronic contacting of the positive electrode.

The aforementioned AlF₃-containing coating as well as the aforementioned carbon-containing coating may also be applied jointly on the active material (A) of the positive electrode, in particular, one above the other, i.e., in layers.

A battery cell is also provided, which includes at least one positive electrode according to the present invention.

A battery cell according to the present invention is advantageously utilized in an electric vehicle (EV), in a hybrid vehicle (HEV), in a plug-in hybrid vehicle (PHEV), in a tool or in a consumer electronics product. Tools are to be understood, in this case, to be, in particular, DIY tools as well as garden tools. Consumer electronics products are, in particular, mobile phones, tablet PCs, or notebooks.

Due to the partial replacement of the oxygen ions O²⁻ by fluoride ions F⁻ and the partial replacement of the manganese ions Mn⁴⁺ by the aluminum ions Al³⁺ in the metal oxide Li₂MnO₃ of the first component (A1) of the active material (A) of the positive electrode, an active material (A) is provided, which ensures a stable voltage when utilized in a lithium-ion battery cell over a relatively long period of time and throughout a high number of cycles. In addition, the structure and the capacity of the lithium-ion battery cell remain stable for a relatively long period of time and throughout a high number of cycles. Voltage loss as well as capacity loss are considerably reduced. Moreover, the doping according to the present invention has a positive effect on the rate capability of the electrode.

Therefore, the service life of the battery increases, whereby a commercial application, in particular, of lithium-ion batteries including an NCM compound in the active material (A) of the positive electrode, becomes possible.

Specific embodiments of the present invention are described in greater detail with reference to the drawings and the following description.

### BRIEF DESCRIPTION OF THE DRAWINGS

FIG. 1 shows a schematic representation of a battery cell.

FIG. 2 shows a schematic representation of a modification of the battery cell from FIG. 1.

FIG. 3 shows a comparison of redox potentials of various electrode materials.

### DETAILED DESCRIPTION

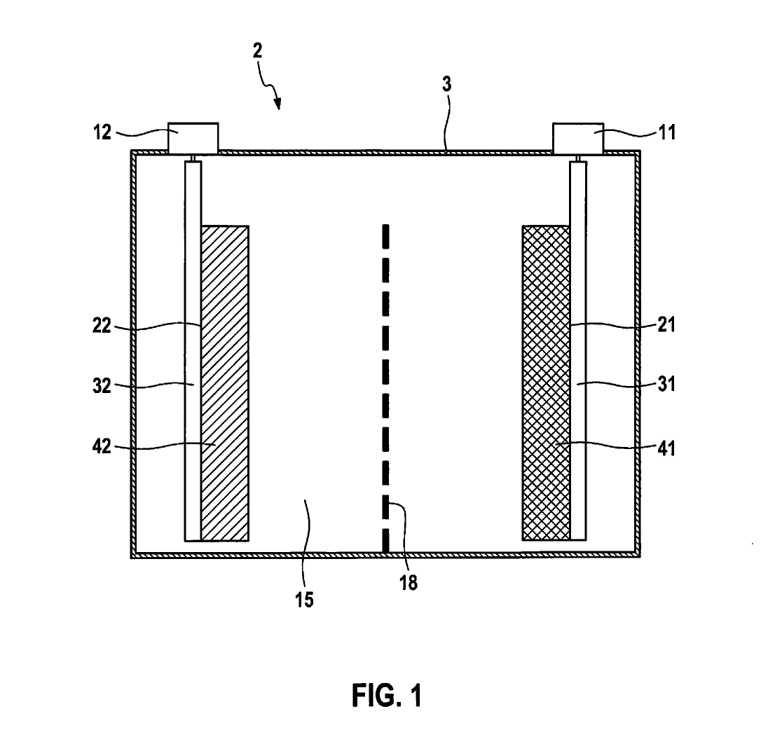

A battery cell 2 is schematically represented in FIG. 1. Battery cell 2 includes a cell housing 3 which is configured to be prismatic, i.e., rectangular in the present case. Cell housing 3 is configured to be electrically conductive in the present case and is made of aluminum, for example. Cell housing 3 may also be made of an electrically insulating material, for example plastic.

Battery cell 2 encompasses a negative terminal 11 and a positive terminal 12. A voltage provided by battery cell 2 may be tapped via terminals 11, 12. Furthermore, battery cell 2 may also be charged via terminals 11, 12. Terminals 11, 12 are situated spaced apart from each other on a cover surface of prismatic cell housing 3.

Situated within cell housing 3 of battery cell 2 is an electrode coil which includes two electrodes, namely a negative electrode 21 and a positive electrode 22. Negative electrode 21 and positive electrode 22 are each configured to be foil-like and are wound to form the electrode coil having a separator 18 therebetween. It is also conceivable that multiple electrode coils are provided in cell housing 3. Instead of the electrode coil, an electrode stack may also be provided, for example.

Negative electrode 21 encompasses a negative active material 41 which is configured to be foil-like. Negative active material 41 includes silicon or a silicon-containing alloy as the base material.

Negative electrode 21 further encompasses a current collector 31 which is likewise configured to be foil-like. Negative active material 41 and current collector 31 are placed against each other in a planar manner and are connected to each other. Current collector 31 of negative electrode 21 is configured to be electrically conductive and is made of a metal, for example copper. Current collector 31 of negative electrode 21 is electrically connected to negative terminal 11 of battery cell 2.

Positive electrode 22 is an HE (high energy)-NCM (nickel-cobalt-manganese) electrode in the present case. Positive electrode 22 encompasses a positive active material (A) 42 which is present in particle form. Additives, in particular conductive carbon black and binders, are situated between the particles of positive active material (A) 42. Positive active material (A) 42 and the aforementioned additives form a composite which is configured to be foil-like.

Positive active material (A) 42 includes a first component (A1) which contains Li₂MnO₃. Moreover, the first component of positive active material (A) 42 includes doping with aluminum fluoride ions which replace at least a portion of the oxygen ions O²⁻ and the manganese ions Mn⁴⁺ of the component Li₂MnO₃. First component (A1) may be additionally doped with natrium ions, so that a portion of the lithium ions is replaced by natrium ions.

Moreover, positive active material (A) 42 includes a second component (A2) which contains an NCM compound, namely LMO₂. M is a transition metal in this case, in particular, selected from nickel, cobalt, and/or manganese. Further components of positive active material (A) 42 are, in particular, PVDF binders, graphite, and carbon black.

Positive electrode 22 further encompasses a current collector 32 which is likewise configured to be foil-like. The composite made up of positive active material (A) 42 and the additives and current collector 32 are placed against each other in a planar manner and are connected to each other. Current collector 32 of positive electrode 22 is configured to be electrically conductive and is made of a metal, for example aluminum. Current collector 32 of positive electrode 22 is electrically connected to positive terminal 12 of battery cell 2.

Negative electrode 21 and positive electrode 22 are separated from each other by separator 18. Separator 18 is likewise configured to be foil-like. Separator 18 is configured to be electronically insulating but ionically conductive, i.e., permeable to lithium ions.

Cell housing 3 of battery cell 2 is filled with a liquid aprotic electrolyte composition 15 or with a polymer electrolyte. Electrolyte composition 15 surrounds negative electrode 21, positive electrode 22, and separator 18 in this case. Electrolyte composition 15 is also ionically conductive and encompasses, for example, a mixture of at least one cyclic carbonate (for example, ethylene carbonate (EC), propylene carbonate (PC), butylene carbonate (BC)), and at least one linear carbonate (for example, dimethyl carbonate (DMC), diethyl carbonate (DEC), methyl ethyl carbonate (MEC)) as solvents, and a lithium salt (for example, LiPF₆, LiBF₄) as an additive.

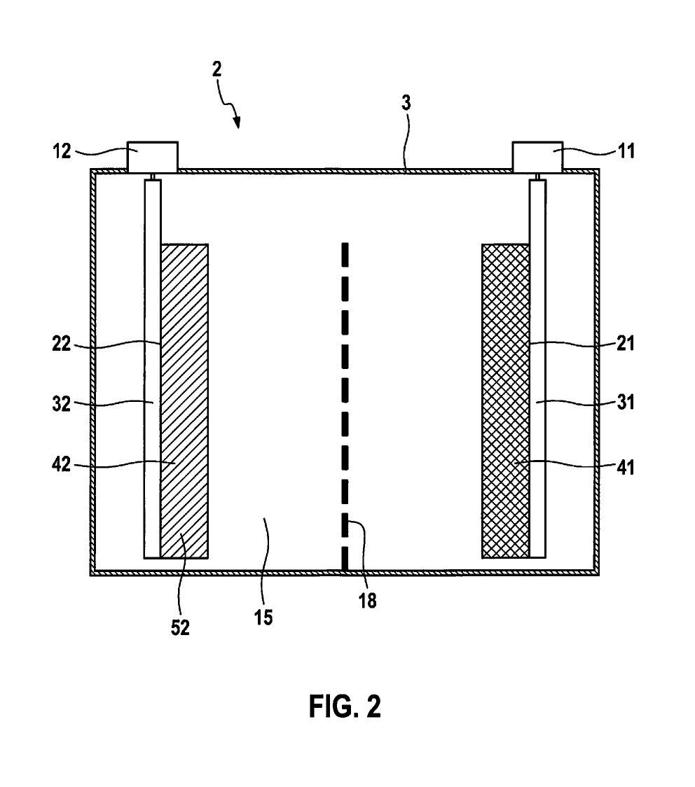

A modification of battery cell 2 from FIG. 1 is schematically represented in FIG. 2. Modified battery cell 2 likewise includes a cell housing 3 which is configured to be prismatic, i.e., rectangular in the present case. Battery cell 2 is largely similar to battery cell 2 from FIG. 1. Therefore, differences from battery cell 2 from FIG. 1, in particular, will be described in the following.

A coating 52 is applied onto the particles of positive active material (A) 42. The particles of positive active material (A) 42 are surrounded by coating 52. Coating 52 therefore surrounds the particles of positive active material (A) 42.

Coating 52 therefore contains aluminum fluoride, i.e., AlF₃, in this case. Coating 52 prevents or reduces a contact of positive active material (A) 42 with electrolyte composition 15 contained in cell housing 3 of battery cell 2. Therefore, washing transition metals out of positive active material (A) 42 and migration of washed-out transition metals to negative electrode 21 of battery cell 2 are likewise prevented or reduced.

Coating 52 may also contain carbon. Such a coating 52 ensures a homogeneous electronic contacting of positive electrode 22. Coating 52 may have, in particular, a multi-layered structure and, for example, contain a layer made up of aluminum fluoride, i.e., AlF₃, and a layer of carbon.

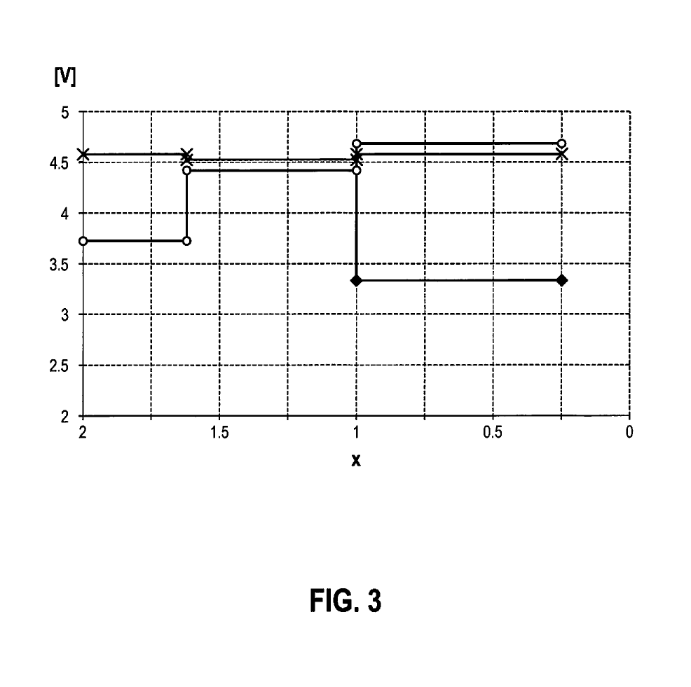

In FIG. 3, a redox potential in volts is plotted on the ordinate against a lithium portion x in LiₓMnO₃ of a first component (A1) on the abscissa. Calculated average voltages of an Li₂MnO₃ component (A1) are contrasted with a non-aged starting material (crosses), an aged material (diamonds), and a material (circles) doped according to the present invention with aluminum fluoride ions.

The present invention is not limited to the exemplary embodiments described here and to the aspects emphasized therein. A multitude of modifications which are within the capabilities of those skilled in the art may rather be possible within the scope described by the claims.

1-10. (canceled)

11. A positive active material for a positive electrode of a battery cell, comprising:
a first component which encompasses a compound of the general formula (II):
Li_{2-z}Na_{z}Mn_{1-y}Al_{y}O_{3-3y}F_{3y} (III)
where 0.15>y>0; and
0.2>z≥0.

12. The positive active material of claim 11, wherein 0.1≥y>0.

13. The positive active material of claim 11, wherein 0.1≥z≥0.05.

14. The positive active material of claim 11, wherein the positive active material encompasses a second component which contains LiMO₂, wherein M is a transition metal from at least one of the elements of nickel, cobalt, and/or manganese.

15. The positive active material of claim 14, wherein the positive active material encompasses a compound having the formula (IV):
a(LiMO₂):1-a(Li_{2-z}Na_{z}Mn_{1-y}Al_{y}O_{3-3y}F_{3y}) (IV)
where 1>a≥0;
0.15>y>0 and
0.2>z≥0.

16. A positive electrode of a battery cell, comprising:
a positive active material for a positive electrode of a battery cell, including a first component which encompasses a compound of the general formula (III):
Li_{2-z}Na_{z}Mn_{1-y}Al_{y}O_{3-3y}F_{3y} (III)
where 0.15>y>0; and
0.2>z≥0.

17. The positive electrode of claim 16, wherein a coating containing AlF₃ is applied on the positive active material.

18. The positive electrode of claim 16, wherein a coating containing carbon is applied on the positive active material.

19. A battery cell, comprising:
at least one positive electrode of a battery cell, including a positive active material for a positive electrode of a battery cell, including a first component which encompasses a compound of the general formula (III):
Li_{2-z}Na_{z}Mn_{1-y}Al_{y}O_{3-3y}F_{3y} (III)
where 0.15>y>0; and
0.2>z≥0.

20. The battery cell of claim 19, wherein the battery cell is used in an electric vehicle (EV), a hybrid vehicle (HEV), a plug-in hybrid vehicle (PHEV), a tool or a consumer electronics product.

21. The positive active material of claim 11, wherein 0.05≥y>0.
